(19) United States
(12) Patent Application Publication
(10) Pub. No.: US 2026/0184119 A1
(43) Pub. Date: Jul. 2, 2026

(54) TIRE STRUCTURE WITH CONTINUOUS CARCASS CORDS AND BELT CORDS AND MANUFACTURING METHOD THEREOF

(71) Applicant: Harbin Institute of Technology, Harbin (CN)

(72) Inventors: Youshan WANG, Harbin (CN); Benlong SU, Harbin (CN)

(73) Assignee: Harbin Institute of Technology, Harbin (CN)

(21) Appl. No.: 19/190,644

(22) Filed: Apr. 27, 2025

(30) Foreign Application Priority Data
Dec. 30, 2024 (CN) 202411966299.6

(51) Int. Cl. B60C 15/06; B60C 9/20

(52) U.S. Cl. CPC B60C 15/0653; B60C 9/20; B60C 15/0607; B60C 2009/2012

(57) ABSTRACT

A tire structure with continuous carcass cords and belt cords, as well as a manufacturing method thereof. The tire structure includes a multi-layer carcass structure with continuous cords and a multi-layer belt structure with continuous cords, where the multi-layer carcass structure with continuous cords is internally coated with a bead wire, an apex layer, and a bead ring wrapper layer. The multi-layer belt structure with continuous cords is attached to the outer side of the multi-layer carcass structure. The present invention can effectively solve breakpoints of a carcass ply layer and a belt ply layer of the traditional tire, so that the stress distribution in the carcass cords and the belt cords is more uniform than existing tire structures. The deformation of the tire at radial and circumferential directions can be significantly reduced.

### TECHNICAL FIELD

The present invention relates to the field of tire technology, and specifically, to a tire structure with continuous carcass cords and belt cords, as well as a manufacturing method thereof.

### BACKGROUND

A traditional all-steel radial truck tire generally uses a multi-layer belt structure, and these belt layers are woven from steel cords and bear the force of the tire during the running with carcass ply layers. In the traditional all-steel radial truck tire, a multi-layer belt structure is adhered to a carcass ply layer, the belt layers are arranged between a carcass and a tread at a specific angle rather than in a radial direction so as to improve the lateral rigidity and the operation performance of the tire. However, a series of cutting points may be generated at the cutting positions of a cord layer, and since the belt layers are discontinuous with the cords inside the carcass, the cords bear unbalanced tension in the running process of the tire, which easily causes the tire to fail or even be damaged under strong impact and high load conditions.

The carcass ply layer of the traditional tire is formed by calendering, cutting, and splicing cords and rubber, a series of cutting points are generated at the cutting positions of a ply layer, and the interface bonding defect exists in the area of the carcass cutting points. During the use of the tire, severe shearing action exists between cord-cutting point areas and rubber; consequently, voids and cracks appear in these areas in the early use stage, the service life of the tire is greatly shortened, and the bearing capacity of the tire is severely limited in this area due to the discontinuity of the cords.

Therefore, how to provide a tire structure with continuous carcass cords and belt cords and a manufacturing method thereof becomes a technical issue to be resolved by those skilled in the art.

### SUMMARY

In view of the foregoing problems in the prior art, the present invention provides a tire structure with continuous carcass cords and belt cords and a manufacturing method thereof, and specifically discloses the following technical solutions:

A tire structure with continuous carcass cords and belt cords includes a multi-layer carcass structure with continuous cords and a multi-layer belt structure with continuous cords, wherein the multi-layer carcass structure with continuous cords is internally coated with a bead wire, an apex layer and a bead ring wrapper, and the multi-layer belt structure with continuous cords is attached to an outer side of the multi-layer carcass structure with continuous cords;
the multi-layer carcass structure with continuous cords is formed by continuously weaving and winding n carcass ply units with continuous cords, wherein a first carcass ply unit with continuous cords is positioned at a center of the multi-layer carcass structure with continuous cords, and a second carcass ply unit with continuous cords is woven and wound on the first carcass ply unit with continuous cords attached with an adhesive layer to form an upper layer and a lower layer; then carcass ply units with continuous cords are sequentially woven and wound to finally form the multi-layer carcass structure with continuous cords with 2n−1^{th} carcass ply layers along a radial direction of the tire; the carcass ply unit with continuous cords is an endless carcass ply tube formed by continuously weaving cords or dipped cords in a zigzag pattern; and
the multi-layer belt structure with continuous cords is formed by bonding k layers of belt plies with continuous cords, a first layer of belt ply with continuous cords is bonded on an outer side of the multi-layer carcass structure with continuous cords attached with an adhesive layer, and the rest layers of belt plies with continuous cords are sequentially bonded on an outer side of the first layer of belt ply with continuous cords to form the multi-layer belt structure with continuous cords.

Further, the tire structure with continuous carcass cords and belt cords further includes a shoulder wedge layer, a sidewall rubber layer and a chafer layer, wherein the shoulder wedge layer, the sidewall rubber layer and the chafer layer are bonded to the multi-layer carcass structure with continuous cords, an innerliner is provided on an inner side of the multi-layer carcass structure with continuous cords, an adhesive layer is attached between ply layers in the multi-layer carcass structure with continuous cords, and a base tread, a cap ply and a cap tread are sequentially attached to an outer side of the multi-layer belt structure with continuous cords.

A manufacturing method of a tire structure with continuous carcass cords and belt cords includes the following steps:
S1. weaving of a first carcass ply unit with continuous cords: preparing two bead wires to be fixed in parallel at a certain interval, coating apex layers on the bead wires along a circumferential direction, selecting a dipped cord or a cord strip consisting of a plurality of dipped cords, reserving a section of length to fix the dipped cord or the cord strip on one of the apex layers, then winding the dipped cord or the cord strip on another lower apex layer at a certain tension and angle, continuously winding for 360 degrees along the circumferential direction in a zigzag pattern, simultaneously calendering the dipped cord or the cord strip into a layer by using an extrusion roller, and finally connecting the dipped cord or the cord strip at a calculated connection point to form the first carcass ply unit with continuous cords;
S2. weaving of a 2−n^{th} carcass ply unit with continuous cords: coating rubber layers on an upper surface and a lower surface of the first carcass ply unit with continuous cords, selecting a dipped cord or a cord strip consisting of a plurality of dipped cords, reserving a section of length, fixing one end of the dipped cord or the cord strip on the first carcass ply unit with continuous cords, weaving the dipped cord or the cord strip on the first carcass ply unit with continuous cords at a certain tension and angle, simultaneously calendering the dipped cord or the cord strip by using an extrusion roller, and finally connecting the dipped cord or the cord strip at a calculated connecting point to form a second carcass ply unit with continuous cords, wherein the second carcass ply unit with continuous cords is divided into an upper layer and a lower layer along a radial direction of the tire, and so on until the weaving of a n^{th} carcass ply unit with continuous cords is completed, and finally forming a multi-layer carcass structure with continuous cords;
S3. material preparation: preparing other structural layers required by tire production and manufacturing, cutting an innerliner, a shoulder wedge layer, a sidewall rubber layer, a bead ring wrapper and a chafer layer with corresponding lengths, and attaching the layers to the multi-layer carcass structure with continuous cords according to a structural size and a position of the tire to obtain a semi-finished component of a rubber tire with the multi-layer carcass structure with continuous cords;
S4. molding: filling the semi-finished component made in the step S2 with air at a certain pressure to mold the semi-finished component of the tire;
S5. weaving of a multi-layer belt structure with continuous cords: selecting a dipped cord or a cord strip consisting of a plurality of dipped cords, circumferentially winding and weaving the dipped cord or the cord strip along an outer side of the multi-layer carcass structure with continuous cords at a certain tension and angle from a set belt width until a woven width reaches the set belt width to form a first layer of belt ply with continuous cords, and sequentially bonding the rest layers of belt plies with continuous cords to form the multi-layer belt structure with continuous cords;
S6. laminating a tread rubber layer on the multi-layer belt structure with continuous cords to obtain an unvulcanized green tire of a rubber tire with a continuous cord structure; and
S7. vulcanization: heating and pressurizing the prepared green tire by using a vulcanizing machine for vulcanization, and obtaining the rubber tire with the continuous cord structure after the vulcanization is completed.

Further, a winding angle of a single dipped cord or a cord strip in the multi-layer carcass structure with continuous cords forms an included angle of 0.1° to 3° or −0.1° to −3° with an axial direction of the tire, and a winding angle of a single dipped cord or a cord strip in the multi-layer belt structure with continuous cords forms an included angle of 0.1° to 30° or −0.1° to −30° with a tread center plane of the tire.

Further, a winding angle of the 2−n^{th} carcass ply unit with continuous cords should maintain a symmetrical relationship, including an angle of a dipped cord or a cord strip on an upper layer of carcass layers being opposite to an angle of a dipped cord or a cord strip on a lower layer, an angle of a dipped cord or a cord strip on an upper layer of carcass layers being opposite to an angle of a dipped cord or a cord strip on an adjacent upper layer, and an angle of a dipped cord or a cord strip on a lower layer of carcass layers being opposite to an angle of a dipped cord or a cord strip on an adjacent lower layer.

Further, after the dipped cord or the cord strip in the multi-layer carcass structure with continuous cords is continuously wound in a zigzag pattern, an endpoint returns to a start point, and a connection between the start point and the endpoint is achieved by butt joint and/or overlap joint.

Further, the apex layer is circumferentially arranged along the bead wire, and the bead ring wrapper is made of a rubber strip or a woven ply layer.

Further, the multi-layer belt structure with continuous cords is provided with an even number of belt ply layers having continuous cords, and winding angles of inner cords of two adjacent layers of belt plies with continuous cords are arranged symmetrically.

Further, a thickness of the dipped cord continuously woven in the multi-layer carcass structure with continuous cords and the multi-layer belt structure with continuous cords is 0.5 to 2 times a diameter of the cord, and the cords of the multi-layer carcass structure with continuous cords and the multi-layer belt structure with continuous cords include steel wires, nylon, Aramid fiber, and a nylon and Aramid hybrid material.

Further, the multi-layer carcass structure with continuous cords and the multi-layer belt structure with continuous cords are bonded directly or by an adhesive layer, and when bonding is achieved by the adhesive layer, a thickness of the adhesive layer is greater than a diameter of the carcass cord.

Further, the carcass ply unit with continuous cords and the belt ply layer with continuous cords are all ply tubes formed by continuously and uniformly winding a single dipped cord or a cord strip consisting of a plurality of dipped cords; the cords in the cord strip consisting of the plurality of dipped cords are uniformly distributed, and a number of the cords is 2-8.

Compared with the conventional technology, the present invention has the beneficial effects.

According to the present invention, the multi-layer carcass structure with continuous cords and the multi-layer belt structure with continuous cords are arranged, so that the continuous transmission of the tension of a tire in a direction of a tire reinforcement material in an inflated and loaded state is ensured, the integral rigidity of the tire is improved, the sizes of all components of the tire may be reduced, the weight of the tire may be further greatly reduced, and the industrial technical problems of discontinuous rigidity and interface bonding defects at the breakpoints of a carcass ply layer structure and a belt ply layer structure in the conventional tire may be solved.

The present invention can effectively solve breakpoints of a carcass ply layer and a belt ply layer of the traditional tire so that the carcass cord and the belt cord continuously transmit tension and control radial and circumferential deformation of the tire; and the rigidity of components of the tire may be effectively improved by continuously transmitting the tension of the tire reinforcement structure, so that the bearing capacity, the impact resistance, the high-speed performance and the service life of the tire are greatly improved.

### BRIEF DESCRIPTION OF DRAWINGS

FIG. 1 is a cross-sectional schematic diagram of a tire structure with continuous carcass cords and belt cords according to the present invention;

FIG. 2 is a schematic winding diagram of the first carcass ply unit with continuous cords of a tire structure with continuous carcass cords and belt cords according to the present invention;

FIG. 3 is a schematic diagram of a cord arrangement angle of the first carcass ply unit with continuous cords of a tire structure with continuous carcass cords and belt cords according to the present invention;

FIG. 4 is a schematic winding diagram of a 2−n^{th} carcass ply unit with continuous cords of a tire structure with continuous carcass cords and belt cords according to the present invention;

FIG. 5 is a schematic diagram of a cord arrangement angle of a 2−n^{th} carcass ply unit with continuous cords of a tire structure with continuous carcass cords and belt cords according to the present invention;

FIG. 6 is a schematic diagram of a structure of a first carcass ply unit with continuous cords of a tire structure with continuous carcass cords and belt cords according to the present invention;

FIG. 7 is a schematic diagram of a structure of a 2−n^{th} carcass ply unit with continuous cords of a tire structure with continuous carcass cords and belt cords according to the present invention;

FIG. 8 is a schematic diagram of structures of first and 2−n^{th} carcass ply units with continuous cords of a tire structure with continuous carcass cords and belt cords according to the present invention; (the green line is a cord of the first carcass ply unit with continuous cords; the red line is a cord of the 2−n^{th} carcass ply unit with continuous cords;)

FIG. 9 is a schematic winding diagram of a belt ply layer with continuous cords of a tire structure with continuous carcass cords and belt cords according to the present invention;

FIG. 10 is a schematic diagram of a structure of a belt ply layer with continuous cords of a tire structure with continuous carcass cords and belt cords according to the present invention;

FIG. 11 is a schematic diagram of the arrangement of an apex layer on a bead wire of a tire structure with continuous carcass cords and belt cords according to the present invention;

FIG. 12 is a schematic diagram of a cord strip composed of a single cord coated with rubber and a plurality of cords coated with rubber in a ply layer structure according to the present invention;

FIG. 13 is a diagram showing the variation of an outer profile of a tire having a conventional multi-layer carcass and belt ply structure;

FIG. 14 is a diagram showing the variation of an outer profile of a tire structure with continuous carcass cords and belt cords according to the present invention; and

FIG. 15 is a schematic diagram showing parameters of each part of a tire structure with continuous carcass cords and belt cords according to the present invention.

Reference numerals: 1: bead wire, 2: apex layer, 3: airtight layer, 4: multi-layer carcass structure with continuous cords, 5: shoulder wedge layer, 6: multi-layer belt structure with continuous cords, 7: cap tread, 8: cap ply, 9: base tread, 10: sidewall rubber layer, 11: chafer layer, and 12: bead ring wrapper.

### DETAILED DESCRIPTION OF EMBODIMENTS

The following clearly and completely describes the technical solutions in the embodiments of the present invention with reference to drawings in the embodiments of the present invention. It is clear that the described embodiments are merely a part rather than all of the embodiments of the present invention. Based on the embodiments of the present invention, all other embodiments obtained by those of ordinary skill in the art without creative effort fall within the protection scope of the present invention.

The present invention provides a tire structure with continuous carcass cords and belt cords, which is used to improve the impact resistance and the bearing capacity of a tire. The continuous cord tension structure design of the tire aims to eliminate the continuous cutting points of the ply layers in traditional tire manufacturing, thereby reducing the possibility of holes and cracks forming near these cutting points. In addition, the present invention further provides a stable and continuous force transmission structure to enhance the force transmission efficiency between the carcass and the bead wire.

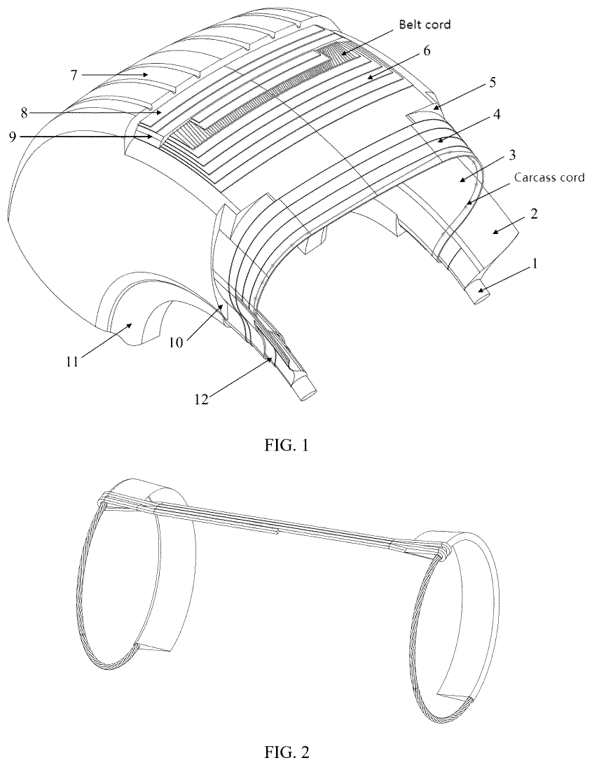

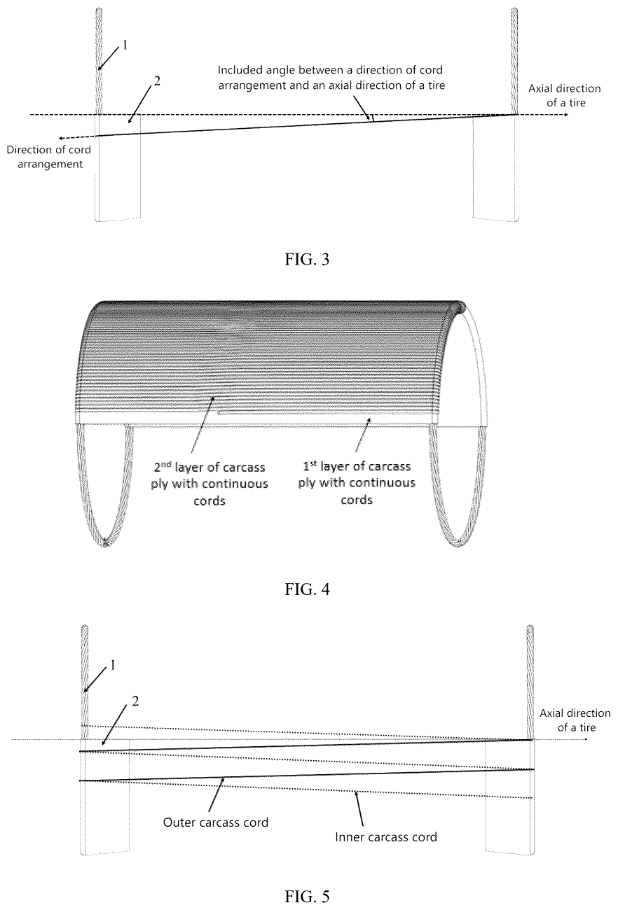

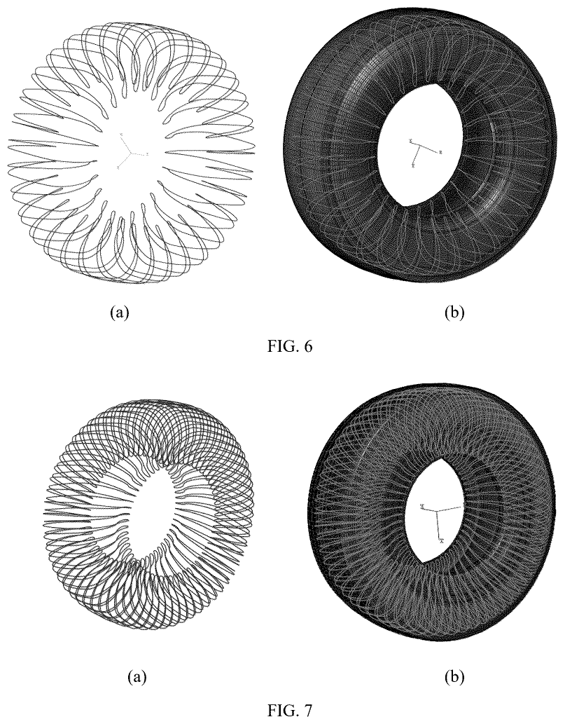

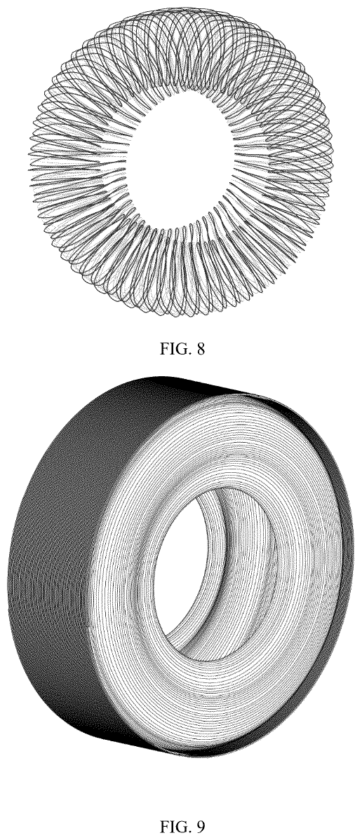

To achieve the above purpose, referring to FIG. 1, the present invention provides a tire structure with continuous carcass cords and belt cords, which includes a multi-layer carcass structure with continuous cords 4, a multi-layer belt structure with continuous cords 6, a shoulder wedge layer 5, a sidewall rubber layer 10 and a chafer layer 11, an innerliner 3 is arranged on an inner side of the multi-layer carcass structure with continuous cords 4, an adhesive layer is attached between ply layers in the multi-layer carcass structure with continuous cords 4, the multi-layer carcass structure with continuous cords 6 is arranged on an outer side of the multi-layer carcass structure with continuous cords 4, the shoulder rubber layer 5, the sidewall rubber layer 10 and the chafer layer 11 are all bonded to the multi-layer carcass structure with continuous cords 4, a bead wire 1, an apex layer 2 and a bead ring wrapper 12 are wrapped inside the multi-layer carcass structure with continuous cords 4, and a base tread 9, a cap ply 8 and a cap tread 7 are sequentially attached to an outer side of the multi-layer belt structure with continuous cords 6.

According to a further optimized technical solution, the multi-layer carcass structure with continuous cords 4 is formed by continuously weaving and winding n carcass ply units with continuous cords, wherein a first carcass ply unit with continuous cords is positioned at the center of the multi-layer carcass structure with continuous cords 4, and a second carcass ply unit with continuous cords is woven and wound on the first carcass ply unit with continuous cords attached with an adhesive layer to form an upper layer and a lower layer; then carcass ply units with continuous cords are sequentially woven and wound to finally form the multi-layer carcass structure with continuous cords 4 with 2n−1^{th} carcass ply layers along a radial direction of the tire; the carcass ply unit with continuous cords is an endless carcass ply tube formed by continuously weaving cords or dipped cords in a zigzag pattern; and
the multi-layer belt structure with continuous cords 6 is formed by bonding k layers of belt plies with continuous cords, a first layer of belt ply with continuous cords is bonded on an outer side of the multi-layer carcass structure with continuous cords 4 attached with an adhesive layer, and the rest layers of belt plies with continuous cords are sequentially bonded on an outer side of the first layer of belt ply with continuous cords to form the multi-layer belt structure with continuous cords 6.

The present invention further provides a manufacturing method of a tire structure with continuous carcass cords and belt cords, which includes the following steps:
S1. weaving of a first carcass ply unit with continuous cords: preparing two bead wires to be fixed in parallel at a certain interval, coating apex layers on the bead wires along a circumferential direction, selecting a dipped cord or a cord strip consisting of a plurality of dipped cords, reserving a section of length to fix the dipped cord or the cord strip on one of the apex layers, then winding the dipped cord or the cord strip on another lower apex layer at a certain tension and angle, continuously winding for 360 degrees along the circumferential direction in a zigzag pattern, simultaneously calendering the dipped cord or the cord strip into a layer by using an extrusion roller, and finally connecting the dipped cord or the cord strip at a calculated connection point to form the first carcass ply unit with continuous cords;
S2. weaving of a 2−n^{th} carcass ply unit with continuous cords: coating rubber layers on an upper surface and a lower surface of the first carcass ply unit with continuous cords, selecting a dipped cord or a cord strip consisting of a plurality of dipped cords, reserving a section of length, fixing one end of the dipped cord or the cord strip on the first carcass ply unit with continuous cords, weaving the dipped cord or the cord strip on the first carcass ply unit with continuous cords at a certain tension and angle, simultaneously calendering the dipped cord or the cord strip by using an extrusion roller, and finally connecting the dipped cord or the cord strip at a calculated connecting point to form a second carcass ply unit with continuous cords, wherein the second carcass ply unit with continuous cords is divided into an upper layer and a lower layer along a radial direction of the tire, and so on until the weaving of a n^{th} carcass ply unit with continuous cords is completed, and finally forming a multi-layer carcass structure with continuous cords;
S3. material preparation: preparing other structural layers required by tire production and manufacturing, cutting an innerliner, a shoulder wedge layer, a sidewall rubber layer, a bead ring wrapper and a chafer layer with corresponding lengths, and attaching the layers to the multi-layer carcass structure with continuous cords according to a structural size and a position of the tire to obtain a semi-finished component of a rubber tire with the multi-layer carcass structure with continuous cords;
S4. molding: filling the semi-finished component made in the step S2 with air at a certain pressure to mold the semi-finished component of the tire;
S5. weaving of a multi-layer belt structure with continuous cords: selecting a dipped cord or a cord strip consisting of a plurality of dipped cords, circumferentially winding and weaving the dipped cord or the cord strip along an outer side of the multi-layer carcass structure with continuous cords at a certain tension and angle from a set belt width until a woven width reaches the set belt width to form a first layer of belt ply with continuous cords, and sequentially bonding the rest layers of belt plies with continuous cords to form the multi-layer belt structure with continuous cords;
S6. laminating a tread rubber layer on the multi-layer belt structure with continuous cords to obtain an unvulcanized green tire of a rubber tire with a continuous cord structure; and
S7. vulcanization: heating and pressurizing the prepared green tire by using a vulcanizing machine for vulcanization, and obtaining the rubber tire with the continuous cord structure after the vulcanization is completed.

According to a further optimized technical solution, a winding angle of a single dipped cord or a cord strip in the multi-layer carcass structure with continuous cords 4 forms an included angle of 0.1° to 3° or −0.1° to −3° with an axial direction of the tire, and a winding angle of a single dipped cord or a cord strip in the multi-layer belt structure with continuous cords 6 forms an included angle of 0.1° to 30° or −0.1° to −30° with a tread center plane of the tire.

According to a further optimized technical solution, a winding angle of the 2−n^{th} carcass ply unit with continuous cords should maintain a symmetrical relationship, including an angle of a dipped cord or a cord strip on an upper layer of carcass layers being opposite to an angle of a dipped cord or a cord strip on a lower layer, an angle of a dipped cord or a cord strip on an upper layer of carcass layers being opposite to an angle of a dipped cord or a cord strip on an adjacent upper layer, and an angle of a dipped cord or a cord strip on a lower layer of carcass layers being opposite to an angle of a dipped cord or a cord strip on an adjacent lower layer.

According to a further optimized technical solution, after the dipped cord or the cord strip in the multi-layer carcass structure with continuous cords 4 is continuously wound in a zigzag pattern, an endpoint returns to a start point, and a connection between the start point and the endpoint is achieved by butt joint and/or overlap joint.

According to a further optimized technical solution, a starting position of continuous weaving of the dipped cord or the cord strip in the multi-layer carcass structure with continuous cords 4 is determined by finite element analysis or a tension calculation formula, the stress distribution condition of the tire with the multi-layer carcass structure with continuous cords under the conditions of inflation and load is calculated by adopting a finite element method, and a position with a minimum carcass cord tension is selected as the starting position of continuous weaving of the carcass ply structure with continuous cords.

According to a further optimized technical solution, the apex layer 2 is circumferentially arranged along the bead wire 1, and the bead ring wrapper 12 is made of a rubber strip or a woven ply layer.

According to a further optimized technical solution, the multi-layer belt structure with continuous cords 6 is provided with an even number of belt ply layers having continuous cords, and winding angles of inner cords of two adjacent layers of belt plies with continuous cords are arranged symmetrically.

According to a further optimized technical solution, the cords in a cord strip consisting of a plurality of dipped cords are uniformly distributed, the distribution interval is determined by a structural design of a tire, and the number of the cords is 2-8.

According to a further optimized technical solution, a thickness of the dipped cord continuously woven in the multi-layer carcass structure with continuous cords and the multi-layer belt structure with continuous cords is 0.5 to 2 times a diameter of the cord, and the cords of the multi-layer carcass structure with continuous cords 4 and the multi-layer belt structure with continuous cords 6 include steel wires, nylon, Aramid fiber, and a nylon and Aramid hybrid material.

According to a further optimized technical solution, the multi-layer carcass structure with continuous cords and the multi-layer belt structure with continuous cords are bonded directly or by an adhesive layer, and when bonding is achieved by the adhesive layer, a thickness of the adhesive layer is greater than a diameter of the carcass cord.

According to the present invention, the multi-layer carcass structure with continuous cords and the multi-layer belt structure with continuous cords are arranged, so that the continuous transmission of the tension of a tire in a direction of a framework material in an inflated and loaded state is ensured, the integral rigidity of the tire is improved, the sizes of all components of the tire may be reduced, the weight of the tire may be further greatly reduced, and the industrial technical problems of discontinuous rigidity and interface bonding defects at the breakpoints of a carcass ply layer structure and a belt ply layer structure in the conventional tire may be solved.

The present invention can effectively solve breakpoints of a carcass ply layer and a belt ply layer of the traditional tire, so that the carcass cord and the belt cord continuously transmit tension and control radial and circumferential deformation of the tire; and the rigidity of components of the tire may be effectively improved by continuously transmitting the tension of the tire framework, so that the bearing capacity, the impact resistance, the high-speed performance and the service life of the tire are greatly improved.

### Example 1

Finite element analysis was performed on a tire with a multi-layer zigzag carcass ply structure and a tire structure with continuous carcass cords and belt cords. The specific steps were as follows:
1. A model of a to-be-analyzed tire was selected to acquire relevant geometric parameters and material parameters of the tire of the model, including maximum width, maximum outer diameter, curvature radius, rubber elastic modulus, rubber Poisson's ratio, and the like of the tire, and the parameters were imported into a finite element calculation software.
2. A tire finite element analysis model was established according to the parameters, and the pretreatment of finite element calculation analysis, including unit establishment, material attribute assignment, grid division and the like was completed.
3. The finite element model after the pretreatment was imported into a finite element software calculation module for the calculation to obtain a finite element analysis result of the tire.

The external load conditions for the finite element analysis were a tire inflation pressure of 1.59 MPa and a tire contact area load of 1.8570×10⁵ N.

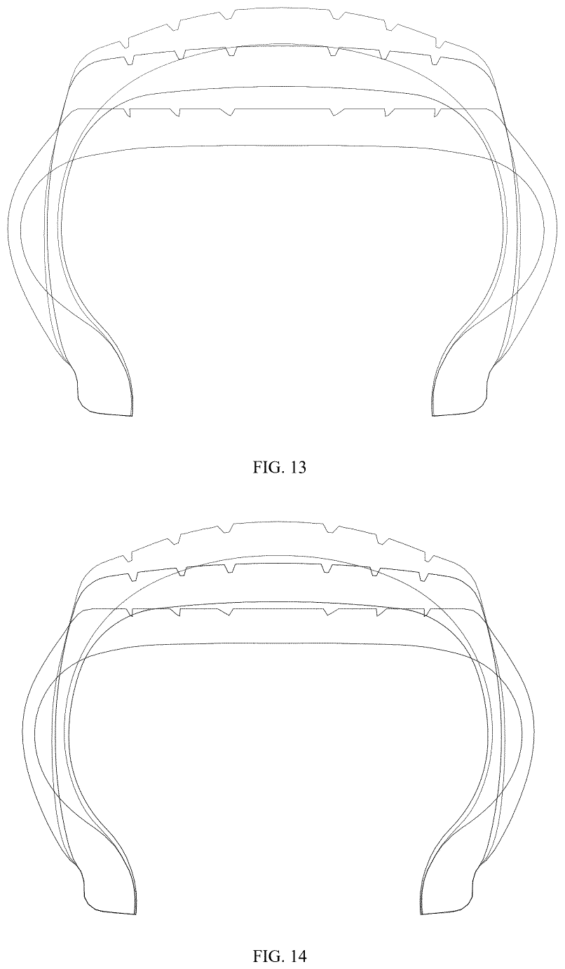

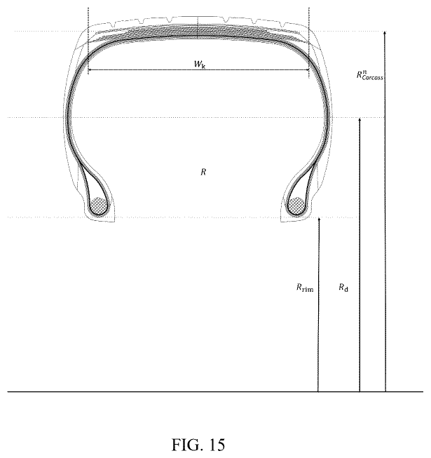

The variation of an outer profile of a tire having a conventional multi-layer carcass and belt ply structure is shown in FIG. 12, and the variation of an outer profile of a tire structure with continuous carcass cords and belt cords is shown in FIG. 13. The section widths and the sinkage of the tires with two different structures under the same boundary condition are compared and analyzed, as shown in Table 1. It may be found that the sinkage of the tire structure with continuous carcass cords and belt cords is reduced by 8.87% and the maximum width after loading is reduced by 1.8% compared with the tire with the conventional multi-layer carcass and belt structure.

TABLE 1

| | | | Maximum | Maximum | Sinking |
|---|---|---|---|---|---|
| | Infla- | | width | width | capacity |
| | tion | Ground | (mm) | (mm) | (mm) |
| | pressure | load | before | after | under |
| | (MPa) | (N) | load | load | load |
| Tire with | 1.59 | 1.8570 × | 386.58 | 451.68 | 83.29 |
| traditional multi- | | 10⁵ | | | |
| layer carcass and | | | | | |
| belt structure | | | | | |
| Tire structure | 1.59 | 1.8570 × | 386.58 | 443.51 | 75.90 |
| with continuous | | 10⁵ | | | |
| carcass cords and | | | | | |
| belt cords | | | | | |

### Example 2

A manufacturing method of a tire structure with continuous carcass cords and belt cords includes the following steps:
S1. weaving of a first carcass ply unit with continuous cords: two bead wires are fixed in parallel at a certain interval, apex layers are coated on the bead wires along a circumferential direction, a dipped cord or a cord strip consisting of a plurality of dipped cords are selected, a section of length is reserved to fix the dipped cord or the cord strip on one of the apex layers, then the dipped cord or the cord strip is wound on another lower apex layer at a certain tension and angle and continuously wound for 360 degrees along the circumferential direction in a zigzag pattern, the dipped cord or the cord strip is simultaneously calendered into a layer by using an extrusion roller, and finally the dipped cord or the cord strip is connected at a calculated connection point to form the first carcass ply unit with continuous cords;
S2. weaving of a 2−n^{th} carcass ply unit with continuous cords: rubber layers are coated on an upper surface and a lower surface of the first carcass ply unit with continuous cords, a dipped cord or a cord strip consisting of a plurality of dipped cords are selected, a section of length is reserved, one end of the dipped cord or the cord strip on the first carcass ply unit with continuous cords is fixed, the dipped cord or the cord strip is woven on the first carcass ply unit with continuous cords at a certain tension and angle, the dipped cord or the cord strip is simultaneously calendered by using an extrusion roller, and finally the dipped cord or the cord strip is connected at a calculated connecting point to form a second carcass ply unit with continuous cords, wherein the second carcass ply unit with continuous cords is divided into an upper layer and a lower layer along a radial direction of the tire, and so on until the weaving of a n^{th} carcass ply unit with continuous cords is completed, and finally forming a multi-layer carcass structure with continuous cords;
S3. material preparation: other structural layers required by tire production and manufacturing are prepared, an innerliner, a shoulder wedge layer, a sidewall rubber layer, a bead ring wrapper and a chafer layer with corresponding lengths are cut, and the layers are attached to the multi-layer carcass structure with continuous cords according to a structural size and a position of the tire to obtain a semi-finished component of a rubber tire with the multi-layer carcass structure with continuous cords;
S4. molding: the semi-finished component made in step S2 is filled with air at a certain pressure to mold the semi-finished component of the tire;
S5. weaving of a multi-layer belt structure with continuous cords: a dipped cord or a cord strip consisting of a plurality of dipped cords is selected, the dipped cord or the cord strip is circumferentially wound and woven along an outer side of the multi-layer carcass structure with continuous cords at a certain tension and angle from a set belt width until a woven width reaches the set belt width to form a first layer of belt ply with continuous cords, and the rest layers of belt plies with continuous cords are sequentially bonded to form the multi-layer belt structure with continuous cords;
S6. a tread rubber layer is laminated on the multi-layer belt structure with continuous cords to obtain an unvulcanized green tire of a rubber tire with a continuous cord structure; and
S7. vulcanization: the prepared green tire is heated and pressurized by using a vulcanizing machine for vulcanization, and the rubber tire with the continuous cord structure is obtained after the vulcanization is completed.

According to a further optimized technical solution, a winding angle of a single dipped cord or a cord strip in the multi-layer carcass structure with continuous cords 4 forms an included angle of 0.1° to 3° or −0.1° to −3° with an axial direction of the tire, and a winding angle of a single dipped cord or a cord strip in the multi-layer belt structure with continuous cords 6 forms an included angle of 0.1° to 30° or −0.1° to −30° with a tread center plane of the tire.

The width of a cord strip formed after a single cord is coated with rubber is b, the thickness of the cord strip is h, the radius of a bead wire coated with an apex layer is represented by Rᵣᵢₘ, a section of the bead wire is approximate to a circular section, a diameter of the bead wire is represented as d, the number of winding turns of the cord strip in the first carcass ply with continuous cords is N₁, which is calculated according to a formula (1), and the number of winding turns of the cord strip in the 2−n^{th} carcass ply with continuous cords is N_{2˜n}, which is calculated according to a formula (2). Preferably, the width of the single cord after being coated with rubber is 2-4 mm, and the cord strip may be formed by 2-8 dipped cords.

According to FIG. 2, a first carcass ply unit with continuous cords has a spacing b between every two cord strips; one turn of winding is formed by arranging two cord strips, and a total of 2N₁ cord strips are arranged in the entire single-layer carcass ply with continuous cords, as shown in formula (1):

$${N}_{1} = \frac{π ( {R}_{rim} + \frac{d}{2} )}{b} \qquad ( 1 )$$

As shown in FIG. 4, for the 2−n^{th} carcass ply unit with continuous cords, the rubber coating thickness between carcass plies is H. After one turn of winding, the upper and lower layers of the carcass ply tube are each arranged with a cord strip, and the spacing between every two cord strips is 0. In the entire carcass ply unit with continuous cords, a total of Nₙ cord strips are arranged in a zigzag shape, as shown in formula (2):

$${N}_{n} = \frac{2 π [ {R}_{r i m} + \frac{d}{2} + ( n - 1 ) ( h + H ) ]}{b} , ( n \geq 2 ) \qquad ( 2 )$$

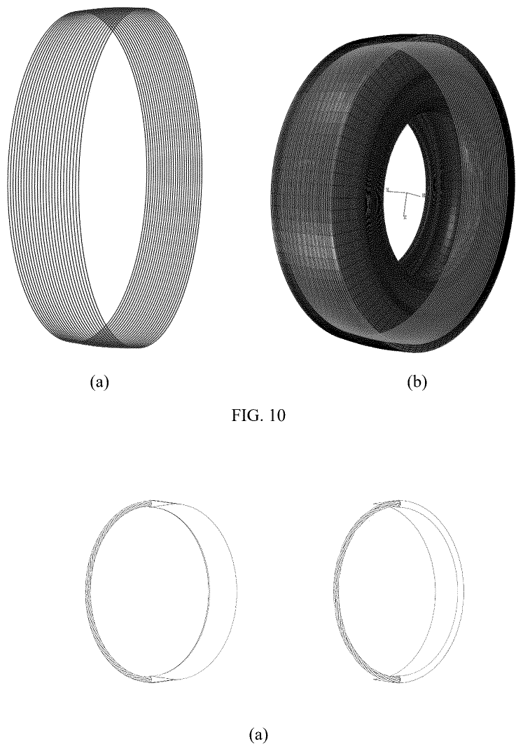

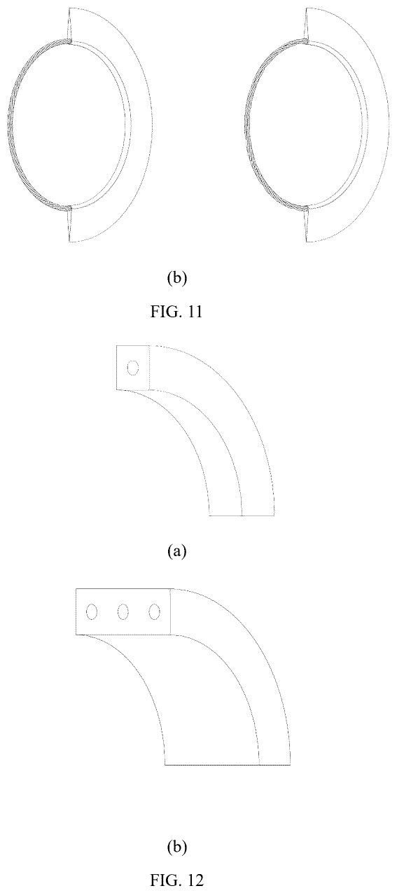

As shown in FIGS. 5 and 10, for the 1−k^{th} layer of belt ply with continuous cords, the width of each layer of belt ply with continuous cords is W_{K}, the rubber coating thickness between the belt ply layers with continuous cords is H, and spacing between every two cord strips is cₖ; a total of Kₖ cord strips are arranged in the entire layer of belt plies with continuous cords, as shown in formula (3):

$${K}_{k} = \frac{{W}_{K}}{{c}_{k} + b} \qquad ( 3 )$$

When a green tire is formed, the carcass ply tube with continuous cords in each layer is deformed, and the radius of each part changes. FIG. 10 is a schematic diagram of a formed tire, where Rᵣᵢₘ is a contact radius of a rim, R_{d} is a radius at a maximum tire width position,

$${R}_{C a r c a s s}^{m}$$

is a maximum radius of a first carcass cord unit with continuous cords after the tire is formed, and W_{K} is a width of each layer of belt ply. The density of the cord arrangement in the first carcass cord unit with continuous cords is represented by ρ₁ (unit: cord/mm), and the density

$${ρ}_{rim}^{1} , {ρ}_{d}^{1} and {ρ}_{m}^{1}$$

(unit: cord/mm) of the cord arrangement in each part of the formed first carcass ply unit with continuous cords are shown in formulas (4) to (6).

$${ρ}_{rim}^{1} = {ρ}_{1} = \frac{2 {N}_{1}}{2 π ( {R}_{rim} + \frac{d}{2} )} = \frac{1}{b} \qquad ( 4 )$$

$${ρ}_{d}^{1} = \frac{{R}_{r i m} + \frac{d}{2}}{b \cdot {R}_{d}} \qquad ( 5 )$$

$${ρ}_{m}^{1} = \frac{{R}_{r i m} + \frac{d}{2}}{b \cdot {R}_{C a r c a s s}^{m}} \qquad ( 6 )$$

Similarly, the density

$${ρ}_{rim}^{n} , {ρ}_{d}^{n} and {ρ}_{m}^{n}$$

(unit: cord/mm) of the cord arrangement in each part of the formed 2−n^{th} carcass ply unit with continuous cords are shown by formulas (7) to (9).

$${ρ}_{rim}^{n} = {ρ}_{n} = \frac{{N}_{2 - n}}{2 π [ {R}_{rim} + \frac{d}{2} + ( n - 1 ) ( h + H ) ]} = \frac{1}{b} , ( n \geq 2 ) \qquad ( 7 )$$

$${ρ}_{d}^{n} = \frac{{R}_{r i m} + \frac{d}{2} + ( n - 1 ) ( h + H )}{b \cdot {R}_{d}} , ( n \geq 2 ) \qquad ( 8 )$$

$${ρ}_{m}^{n} = \frac{{R}_{r i m} + \frac{d}{2} + ( n - 1 ) ( h + H )}{b \cdot [ {R}_{C a r c a s s}^{m} + ( n - 1 ) ( h + H ) ]} , ( n \geq 2 ) \qquad ( 9 )$$

The density

$${ρ}_{k}^{K}$$

(unit: cord/mm) of the cord arrangement in the 1−k^{th} layer of belt ply with continuous cords is shown by formula (10):

$${ρ}_{k}^{K} = \frac{{K}_{k}}{{W}_{K}} = \frac{1}{{c}_{k} + b} \qquad ( 10 )$$

The foregoing descriptions are only preferred examples of the present invention and are not construed as any limitation on the technical scope of the present invention. Any minor modifications, equivalent variations, or refinements made to the foregoing examples according to the technical essence of the present invention shall fall within the scope of the technical solutions protected by the present invention.

What is claimed is:

1. A tire structure with continuous carcass cords and belt cords, comprising: a multi-layer carcass structure with continuous cords and a multi-layer belt structure with continuous cords, wherein the multi-layer carcass structure with continuous cords is internally coated with a bead wire, an apex layer, and a bead ring wrapper, and the multi-layer belt structure with continuous cords is attached to an outer side of the multi-layer carcass structure with continuous cords;
the multi-layer carcass structure with continuous cords is formed by continuously weaving and winding n carcass ply units with continuous cords, wherein a first carcass ply unit with continuous cords is positioned at the center of the multi-layer carcass structure, and a second carcass ply unit with continuous cords is woven and wound on the first carcass ply unit with continuous cords attached with an adhesive layer to form an upper layer and a lower layer; then carcass ply units with continuous cords are sequentially woven and wound to finally form the multi-layer carcass structure with continuous cords with 2n−1^{th} carcass ply layers along a radial direction of the tire; the carcass ply unit with continuous cords is a seamless carcass ply cylinder formed by continuously weaving cords or dipped cords in a zigzag pattern; and
the multi-layer belt structure with continuous cords is formed by bonding k layers of belt ply units with continuous cords, a first layer of belt ply units with continuous cords is bonded on the outer side of the multi-layer carcass structure with continuous cords attached with an adhesive layer, and the rest layers of belt ply units with continuous cords are sequentially bonded on an outer side of the first layer of belt ply units with continuous cords to form the multi-layer belt structure with continuous cords.

2. The tire structure with continuous carcass cords and belt cords according to claim 1, further comprising a shoulder wedge layer, a sidewall rubber layer, and a chafer layer, wherein the shoulder wedge layer, the sidewall rubber layer, and the chafer layer are bonded to the multi-layer carcass structure with continuous cords, an innerliner is provided on an inner side of the multi-layer carcass structure with continuous cords, an adhesive layer is attached between ply layers in the multi-layer carcass structure with continuous cords, and a base tread, a cap ply, and a cap tread are sequentially attached to an outer side of the multi-layer belt structure with continuous cords.

3. A manufacturing method of the tire structure with continuous carcass cords and belt cords according to claim 1, comprising the following steps:
S1. weaving of a first carcass ply unit with continuous cords: preparing two bead wires to be fixed in parallel at a certain interval, coating apex layers on the bead wires along a circumferential direction, selecting a dipped cord or a cord strip consisting of a plurality of dipped cords, reserving a section of length to fix the dipped cord or the cord strip on one of the apex layers, then winding the dipped cord or the cord strip on another apex layer at a certain tension and angle, continuously winding for 360 degrees along the circumferential direction in a zigzag pattern, simultaneously calendering the upper and lower layers of the dipped cord or cord strip into a single layer by using an extrusion roller, and finally connecting the dipped cord or the cord strip at a calculated connection point to form the first carcass ply unit with continuous cords;
S2. weaving of a 2−n^{th} carcass ply unit with continuous cords: coating rubber layers on an upper surface and a lower surface of the first carcass ply unit with continuous cords, selecting a dipped cord or a cord strip consisting of a plurality of dipped cords, reserving a section of length, fixing one end of the dipped cord or the cord strip on the first carcass ply unit with continuous cords, weaving the dipped cord or the cord strip on the first carcass ply unit with continuous cords at a certain tension and angle, simultaneously calendering the dipped cord or the cord strip by using an extrusion roller, and finally connecting the dipped cord or the cord strip at a calculated connecting point to form a second carcass ply unit with continuous cords, wherein the second carcass ply unit with continuous cords is divided into an upper layer and a lower layer along a radial direction of the tire, and so on until the weaving of a n^{th} carcass ply unit with continuous cords is completed, and finally forming a multi-layer carcass structure with continuous cords;
S3. material preparation: preparing other structural layers required by tire production and manufacturing, cutting an innerliner, a shoulder wedge layer, a sidewall rubber layer, a bead ring wrapper, and a chafer layer with corresponding lengths, and attaching the layers to the multi-layer carcass structure with continuous cords according to a structural size and a position of the tire to obtain a semi-finished component of a rubber tire with the multi-layer carcass structure with continuous cords;
S4. molding: filling the semi-finished component made in step S2 with air at a certain pressure to mold the semi-finished component of the tire;
S5. weaving of a multi-layer belt structure with continuous cords: selecting a dipped cord or a cord strip consisting of a plurality of dipped cords, circumferentially winding and weaving the dipped cord or the cord strip along an outer side of the multi-layer carcass structure with continuous cords at a certain tension and angle from a set belt width until a woven width reaches the set belt width to form a first layer of belt ply with continuous cords, and sequentially bonding the rest layers of belt plies with continuous cords to form the multi-layer belt structure with continuous cords;
S6. laminating a tread rubber layer on the multi-layer belt structure with continuous cords to obtain an unvulcanized green tire with a continuous cord structure; and
S7. vulcanization: heating and pressurizing the prepared green tire by using a vulcanizing machine for vulcanization, and obtaining the rubber tire with the continuous cords structure after the vulcanization is completed.

4. The manufacturing method of the tire structure with continuous carcass cords and belt cords according to claim 3, wherein a winding angle of a single dipped cord or a cord strip in the multi-layer carcass structure with continuous cords forms an included angle of 0.1° to 3° or −0.1° to −3° with an axial direction of the tire and a winding angle of a single dipped cord or a cord strip in the multi-layer belt structure with continuous cords forms an included angle of 0.1° to 30° or −0.1° to −30° with a tread center plane of the tire.

5. The manufacturing method of the tire structure with continuous carcass cords and belt cords according to claim 3, wherein the winding angles of the 2−n^{th} carcass ply unit with continuous cords should maintain a symmetrical relationship, comprising an angle of a dipped cord or a cord strip on an upper layer of carcass layers being opposite to an angle of a dipped cord or a cord strip on a lower layer, an angle of a dipped cord or a cord strip on an upper layer of carcass layers being opposite to an angle of a dipped cord or a cord strip on an adjacent upper layer, and an angle of a dipped cord or a cord strip on a lower layer of carcass layers being opposite to an angle of a dipped cord or a cord strip on an adjacent lower layer.

6. The manufacturing method of the tire structure with continuous carcass cords and belt cords according to claim 3, wherein after the dipped cord or the cord strip in the multi-layer carcass structure with continuous cords is continuously wound in a zigzag pattern, an endpoint returns to a start point, and a connection between the start point and the endpoint is achieved by butt joint and/or overlap joint.

7. The manufacturing method of the tire structure with continuous carcass cords and belt cords according to claim 3, wherein the apex layer is circumferentially arranged along the bead wire, and the bead ring wrapper is made of a rubber strip or a woven ply layer.

8. The manufacturing method of the tire structure with continuous carcass cords and belt cords according to claim 3, wherein the multi-layer belt structure with continuous cords is provided with an even number of belt ply layers having continuous cords, and winding angles of inner cords of two adjacent layers of belt plies with continuous cords are arranged symmetrically.

9. The manufacturing method of the tire structure with continuous carcass cords and belt cords according to claim 3, wherein the thickness of the dipped cord continuously woven in the multi-layer carcass structure with continuous cords and the multi-layer belt structure with continuous cords is 0.5 to 2 times a diameter of the cord, and the cords of the multi-layer carcass structure with continuous cords and the multi-layer belt structure with continuous cords comprise steel wires, nylon, aramid fiber, and a nylon and aramid hybrid material.

10. The manufacturing method of the tire structure with continuous carcass cords and belt cords according to claim 3, wherein the multi-layer carcass structure with continuous cords and the multi-layer belt structure with continuous cords are bonded directly or by an adhesive layer, and when bonding is achieved by the adhesive layer, a thickness of the adhesive layer is greater than a diameter of the carcass cord.

11. The manufacturing method of the tire structure with continuous carcass cords and belt cords according to claim 3, wherein the carcass ply unit with continuous cords and the belt ply unit with continuous cords are all ply cylinders formed by continuously and uniformly winding a single dipped cord or a cord strip consisting of a plurality of dipped cords; the cords in the cord strip consisting of the plurality of dipped cords are uniformly distributed, and a number of the cords is 2-8.

12. A manufacturing method of the tire structure with continuous carcass cords and belt cords according to claim 2, comprising the following steps:
S1. weaving of a first carcass ply unit with continuous cords: preparing two bead wires to be fixed in parallel at a certain interval, coating apex layers on the bead wires along a circumferential direction, selecting a dipped cord or a cord strip consisting of a plurality of dipped cords, reserving a section of length to fix the dipped cord or the cord strip on one of the apex layers, then winding the dipped cord or the cord strip on another apex layer at a certain tension and angle, continuously winding for 360 degrees along the circumferential direction in a zigzag pattern, simultaneously calendering the upper and lower layers of the dipped cord or cord strip into a single layer by using an extrusion roller, and finally connecting the dipped cord or the cord strip at a calculated connection point to form the first carcass ply unit with continuous cords;
S2. weaving of a 2−n^{th} carcass ply unit with continuous cords: coating rubber layers on an upper surface and a lower surface of the first carcass ply unit with continuous cords, selecting a dipped cord or a cord strip consisting of a plurality of dipped cords, reserving a section of length, fixing one end of the dipped cord or the cord strip on the first carcass ply unit with continuous cords, weaving the dipped cord or the cord strip on the first carcass ply unit with continuous cords at a certain tension and angle, simultaneously calendering the dipped cord or the cord strip by using an extrusion roller, and finally connecting the dipped cord or the cord strip at a calculated connecting point to form a second carcass ply unit with continuous cords, wherein the second carcass ply unit with continuous cords is divided into an upper layer and a lower layer along a radial direction of the tire, and so on until the weaving of a n^{th} carcass ply unit with continuous cords is completed, and finally forming a multi-layer carcass structure with continuous cords;
S3. material preparation: preparing other structural layers required by tire production and manufacturing, cutting an innerliner, a shoulder wedge layer, a sidewall rubber layer, a bead ring wrapper, and a chafer layer with corresponding lengths, and attaching the layers to the multi-layer carcass structure with continuous cords according to a structural size and a position of the tire to obtain a semi-finished component of a rubber tire with the multi-layer carcass structure with continuous cords;
S4. molding: filling the semi-finished component made in step S2 with air at a certain pressure to mold the semi-finished component of the tire;
S5. weaving of a multi-layer belt structure with continuous cords: selecting a dipped cord or a cord strip consisting of a plurality of dipped cords, circumferentially winding and weaving the dipped cord or the cord strip along an outer side of the multi-layer carcass structure with continuous cords at a certain tension and angle from a set belt width until a woven width reaches the set belt width to form a first layer of belt ply with continuous cords, and sequentially bonding the rest layers of belt plies with continuous cords to form the multi-layer belt structure with continuous cords;
S6. laminating a tread rubber layer on the multi-layer belt structure with continuous cords to obtain an unvulcanized green tire with a continuous cord structure; and
S7. vulcanization: heating and pressurizing the prepared green tire by using a vulcanizing machine for vulcanization, and obtaining the rubber tire with the continuous cords structure after the vulcanization is completed.

13. The manufacturing method of the tire structure with continuous carcass cords and belt cords according to claim 12, wherein a winding angle of a single dipped cord or a cord strip in the multi-layer carcass structure with continuous cords forms an included angle of 0.1° to 3° or −0.1° to −3° with an axial direction of the tire and a winding angle of a single dipped cord or a cord strip in the multi-layer belt structure with continuous cords forms an included angle of 0.1° to 30° or −0.1° to −30° with a tread center plane of the tire.

14. The manufacturing method of the tire structure with continuous carcass cords and belt cords according to claim 12, wherein the winding angles of the 2−n^{th} carcass ply unit with continuous cords should maintain a symmetrical relationship, comprising an angle of a dipped cord or a cord strip on an upper layer of carcass layers being opposite to an angle of a dipped cord or a cord strip on a lower layer, an angle of a dipped cord or a cord strip on an upper layer of carcass layers being opposite to an angle of a dipped cord or a cord strip on an adjacent upper layer, and an angle of a dipped cord or a cord strip on a lower layer of carcass layers being opposite to an angle of a dipped cord or a cord strip on an adjacent lower layer.

15. The manufacturing method of the tire structure with continuous carcass cords and belt cords according to claim 12, wherein after the dipped cord or the cord strip in the multi-layer carcass structure with continuous cords is continuously wound in a zigzag pattern, an endpoint returns to a start point, and a connection between the start point and the endpoint is achieved by butt joint and/or overlap joint.

16. The manufacturing method of the tire structure with continuous carcass cords and belt cords according to claim 12, wherein the apex layer is circumferentially arranged along the bead wire, and the bead ring wrapper is made of a rubber strip or a woven ply layer.

17. The manufacturing method of the tire structure with continuous carcass cords and belt cords according to claim 12, wherein the multi-layer belt structure with continuous cords is provided with an even number of belt ply layers having continuous cords, and winding angles of inner cords of two adjacent layers of belt plies with continuous cords are arranged symmetrically.

18. The manufacturing method of the tire structure with continuous carcass cords and belt cords according to claim 12, wherein the thickness of the dipped cord continuously woven in the multi-layer carcass structure with continuous cords and the multi-layer belt structure with continuous cords is 0.5 to 2 times a diameter of the cord, and the cords of the multi-layer carcass structure with continuous cords and the multi-layer belt structure with continuous cords comprise steel wires, nylon, aramid fiber, and a nylon and aramid hybrid material.

19. The manufacturing method of the tire structure with continuous carcass cords and belt cords according to claim 12, wherein the multi-layer carcass structure with continuous cords and the multi-layer belt structure with continuous cords are bonded directly or by an adhesive layer, and when bonding is achieved by the adhesive layer, a thickness of the adhesive layer is greater than a diameter of the carcass cord.

20. The manufacturing method of the tire structure with continuous carcass cords and belt cords according to claim 12, wherein the carcass ply unit with continuous cords and the belt ply unit with continuous cords are all ply cylinders formed by continuously and uniformly winding a single dipped cord or a cord strip consisting of a plurality of dipped cords; the cords in the cord strip consisting of the plurality of dipped cords are uniformly distributed, and a number of the cords is 2-8.
